(19) United States
(12) Patent Application Publication
(10) Pub. No.: US 2016/0004434 A1
(43) Pub. Date: Jan. 7, 2016

(54) Information Input Device and Method

(71) Applicant: Henghao Technology Co., Ltd., Hsinchu County (TW)

(72) Inventors: Ming-Chuan Chih, Hsinchu County (TW); Zhen-Yu Yang, Hsinchu County (TW); Yu-Tung Chen, Hsinchu County (TW)

(21) Appl. No.: 14/789,577

(22) Filed: Jul. 1, 2015

(30) Foreign Application Priority Data
Jul. 3, 2014 (TW) 103123075

(51) Int. Cl. G06F 3/0488; G06F 1/16; G06F 3/041

(52) U.S. Cl. CPC G06F 3/04886; G06F 3/0412; G06F 3/0414; G06F 1/163

(57) ABSTRACT

An information input device includes a pressure sensing unit, a display unit and a processing unit. The pressure sensing unit senses an operating pressure at a at least one press-button point, and generates a signal of the at least one press-button point in a pressure arrangement state. The display unit provides a selection tool and a position target indicating the pressure arrangement state. The processing unit, according to the signal, causes the selection tool to select the position target, and generates an input information representing the pressure arrangement state.

### CROSS-REFERENCE TO RELATED APPLICATION AND CLAIM OF PRIORITY

The application claims the benefit of Taiwan Patent Application No. 103123075, filed on Jul. 3, 2014, at the Taiwan Intellectual Property Office, the disclosure of which is incorporated herein in its entirety by reference.

### TECHNICAL FIELD

The present disclosure relates to an information input device and method and, more particularly, relates to an information input device and method using pressure sensing.

### BACKGROUND

Please refer to FIG. 1, which is a schematic diagram showing a handheld communication device 10 in the prior art. The handheld communication device 10 includes a touch screen 11. In order to perform a dial operation, the handheld communication device 10 uses the touch screen 11 to display a plurality of virtual keys 151, 152, 153, 154, 155, 156, 157, 158, 159, 160, 161 and 162, to display a plurality of numerical symbols “1”, “2”, “3”, “4”, “5”, “6”, “7”, “8”, “9” and “0” respectively on the plurality of virtual keys 151, 152, 153, 154, 155, 156, 157, 158, 159 and 160, and to display two functional symbols “#” and “*” respectively on the two virtual keys 161 and 162. The touch screen 11 senses a button-press on the plurality of virtual keys 151, 152, 153, 154, 155, 156, 157, 158, 159, 160, 161 and 162 to generate an input information. The handheld communication device 10 performs a dial operation according to the input information.

In FIG. 1, the handheld communication device 10 generates the input dial information by sensing a corresponding virtual key on the touch screen 11 to perform a dial operation. For a wearable communication device, such as a watch-form mobile phone, requiring a lightweight and a small volume, it is difficult for the user to dial the number on the wearable communication device with bare hands. Therefore, the user must click on the touch screen 11 of the wearable communication device by means of an auxiliary dial component, such as a stylus; however, this will result in a problem on carrying the auxiliary dial component. On the market, each of many wearable communication devices is configured to include a setting slot for the auxiliary dial component. In this way, although the problem of carrying the auxiliary dial component can be solved, a special auxiliary dial component must be employed. If the special auxiliary dial component is lost or is not returned to the former position after use because of forgetting, it will also result in the abovementioned inconvenience.

Please refer to FIG. 2, which is a schematic diagram showing a handheld communication device 20 in the prior art. The handheld communication device 20 includes a screen 21 and a knob 22 coupled to the screen 21. The screen 21 is configured to include a plurality of predetermined positions 270, 271, 272, 273, 274, 275, 276, 277, 278, 279, 280, 281 and 282, which form an annular arrangement. In order to perform a dial operation, the handheld communication device 20 uses the screen 21 to display a plurality of numerical symbols “1”, “2”, “3”, “4”, “5”, “6”, “7”, “8”, “9” and “0” respectively at the plurality of predetermined positions 271, 272, 273, 274, 275, 276, 277, 278, 279 and 280, to display two functional symbols “#” and “*” respectively at the two predetermined positions 281 and 282, and to display a start reference symbol at the predetermined position 270.

In a start state, the knob 22 is idle, and the handheld communication device 20 uses the screen 21 to display a marking button 291 at the predetermined position 270. The knob 22 is located in the middle portion on the lower side of the screen 21. The user dials the number by turning the knob 22 as the dial operation performed for the traditional rotary dial telephone. If the dial means of the handheld communication device 20 is applied to a wearable communication device, the wearable communication device will have a salient profile and a knob difficult to be turned.

Therefore, there is a demand to develop a new dialing method and device so as to solve the abovementioned inconvenience and to get the aesthetic.

### SUMMARY OF EXEMPLARY EMBODIMENTS

It is an aspect of the present disclosure to solve a problem that cannot correctly dial a number with bare hands because of the too small touch screen, and additionally to get the aesthetic.

It is therefore an embodiment of the present disclosure to provide an information input device. The information input device includes a pressure sensing unit, a display unit and a processing unit. The pressure sensing unit senses an operating pressure at a at least one press-button point, and generates a signal of the at least one press-button point in a pressure arrangement state. The display unit provides a selection tool and a position target indicating the pressure arrangement state. The processing unit, according to the signal, causes the selection tool to select the position target, and generates an input information representing the pressure arrangement state.

It is therefore another embodiment of the present disclosure to provide an information input device. The information input device includes a pressure sensing unit and a processing unit. The pressure sensing unit senses an operating pressure at a at least one press-button point, and generates a signal of the at least one press-button point in a pressure arrangement state, wherein the operating pressure has a respective pressure component at each the at least one press-button point. The processing unit digitizes the respective pressure component through the pressure sensing unit to correspondingly generate a respective digitized pressure component expressed by a plurality of bits to obtain a specific digitized pressure level for the operating pressure, and generates according to the signal an input information representing the pressure arrangement state.

It is therefore still another embodiment of the present disclosure to provide an information input method. The information input method includes the following steps. An operating pressure formed at a at least one press-button point is sensed, wherein the operating pressure has a respective pressure component at each the at least one press-button point. The respective pressure component is digitized to correspondingly generate a respective digitized pressure component expressed by a plurality of bits. A signal is generated when the at least one press-button point is in a pressure arrangement state. An input information representing the pressure arrangement state is generated according to the signal.

### BRIEF DESCRIPTION OF THE DRAWINGS

The foregoing and other features and advantages of the present disclosure will be more clearly understood through the following descriptions with reference to the drawings, wherein:

FIG. 1 is a schematic diagram showing a handheld communication device in the prior art;

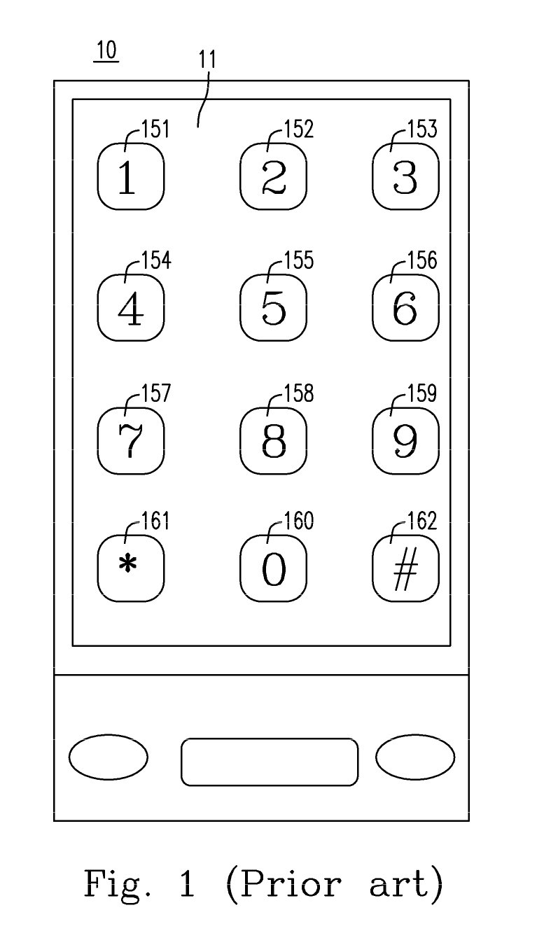

FIG. 2 is a schematic diagram showing a handheld communication device in the prior art;

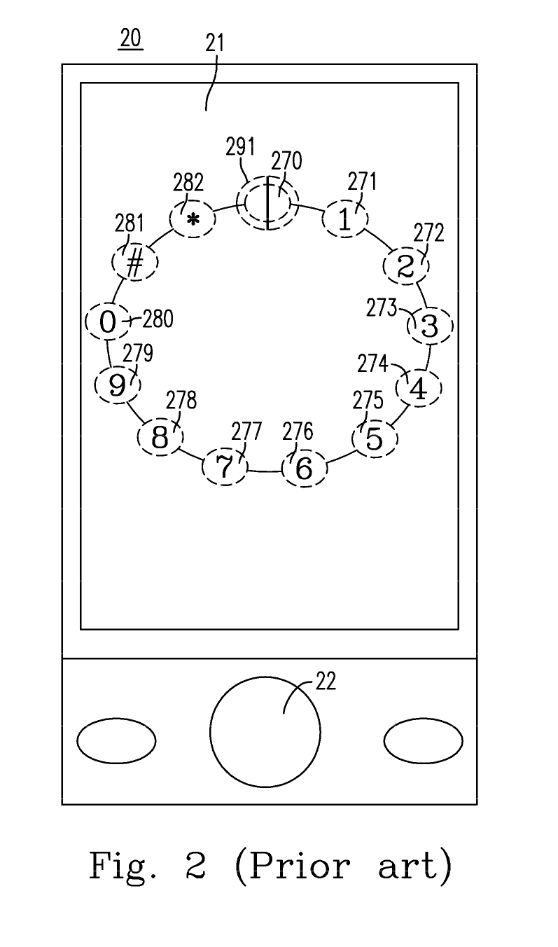

FIG. 3 is a schematic structural diagram showing an information input device according to various embodiments of the present disclosure;

FIG. 4 is a schematic structural diagram showing an information input device according to various embodiments of the present disclosure;

FIG. 5 is a schematic structural diagram showing an information input device according to various embodiments of the present disclosure;

FIG. 6 is a schematic structural diagram showing an information input device according to various embodiments of the present disclosure;

FIG. 7 is a schematic structural diagram showing an information input device according to various embodiments of the present disclosure; and

FIG. 8A and FIG. 8B are schematic structural diagrams respectively showing a front view and a back view of an information input device according to various embodiments of the present disclosure.

### DETAIL DESCRIPTION OF THE PREFERRED EMBODIMENTS

The present disclosure will now be described more specifically with reference to the following embodiments. It is to be noted that the following descriptions of preferred embodiments of this disclosure are presented herein for the purposes of illustration and description only; it is not intended to be exhaustive or to be limited to the precise form disclosed.

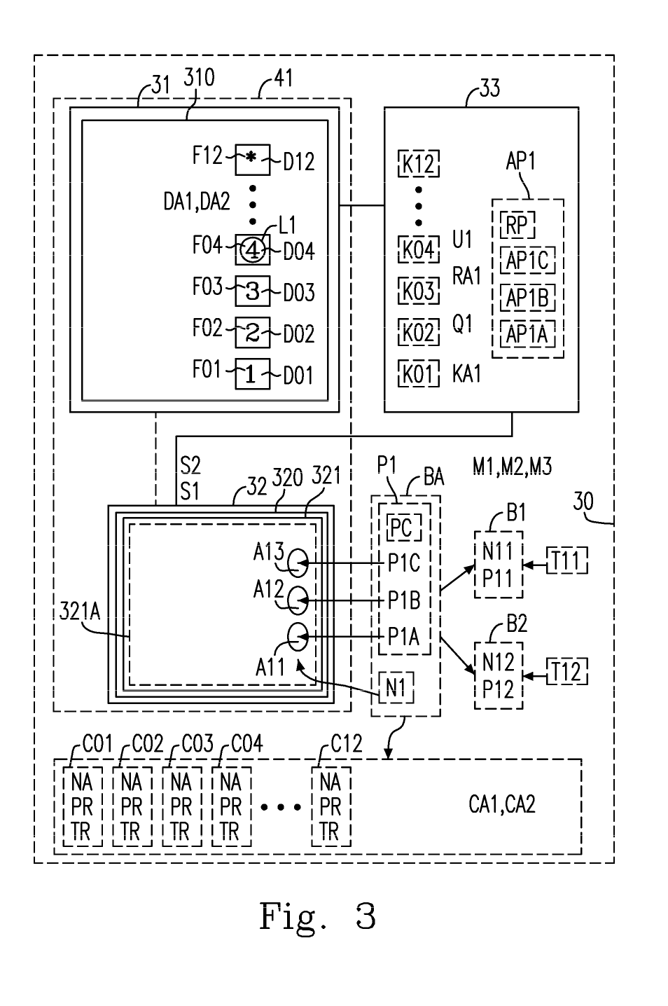

Please refer to FIG. 3, which is a schematic structural diagram showing an information input device 30 according to various embodiments of the present disclosure. The information input device 30 includes a display unit 31, a pressure sensing unit 32 and a processing unit 33. Each of the display unit 31 and the pressure sensing unit 32 is coupled to the processing unit 33. The pressure sensing unit 32 senses at least one press-button point A11 and an operating pressure P1 formed at the at least one press-button point A11, and generates a signal S1 under a condition that a combination form B1 of a count N1 of the at least one press-button point A11 and the operating pressure P1 is in a pressure arrangement state CAL The display unit 31 provides a selection tool L1 and a position target DA1 indicating the pressure arrangement state CAL The processing unit 33, according to the signal S1, causes the display unit 31 to use the selection tool L1 to select the position target DA1, and generates an input information Q1 representing the pressure arrangement state CAL

In some embodiments, a combination BA of the count N1 of the at least one press-button point A11 and the operating pressure P1 exists a plurality of pressure arrangement states C01, C02, C03, C04 . . . and C12, wherein the plurality of pressure arrangement states C01, C02, C03, C04 . . . and C12 are predetermined, and include the pressure arrangement state CA1 and a pressure arrangement state CA2 different from the pressure arrangement state CAL For instance, the pressure arrangement states CA1 and CA2 are equal to the pressure arrangement states C04 and C02, respectively. Each of the plurality of pressure arrangement states C01, C02, C03, C04 . . . and C12 has a respective press-button point count NA and a respective pressure range PR to cause the plurality of pressure arrangement states C01, C02, C03, C04 . . . and C12 to respective have a plurality of pressure ranges. The display unit 31 provides a plurality of position targets D01, D02, D03, D04 . . . and D12 associated with the selection tool L1, wherein the plurality of position targets D01, D02, D03, D04 . . . and D12 respectively indicate the plurality of pressure arrangement states C01, C02, C03, C04 . . . and C12, and include the position target DA1. For instance, the position target DA1 is the position target D04; the selection tool L1 is a mark; and the plurality of position targets D01, D02, D03, D04 . . . and D12 are fixed.

The combination BA of the count N1 of the at least one press-button point A11 and the operating pressure P1 is equal to the combination form B1 at a specific time T11, and is equal to a combination form B2 at a specific time T12 earlier than the specific time T11. The count N11 of the at least one press-button point A11 is equal to an integer N11 at the specific time T11, and is equal to an integer N12 at the specific time T12. The operating pressure P1 is equal to a pressure level P11 at the specific time T11, and is equal to a pressure level P12 at the specific time T12. For instance, the pressure level P11 is higher than the pressure level P12.

The combination form B1 includes the integer N11 and the pressure level P11, wherein the integer N11 is equal to the respective press-button point count NA of the pressure arrangement state CA1, and the pressure level P11 is in the respective pressure range PR of the pressure arrangement state CAL The operating pressure P1 has a respective pressure component PC at each the at least one press-button point A11. The processing unit 33 digitizes the respective pressure component PC through the pressure sensing unit 32 to correspondingly generate a respective digitized pressure component RP, and obtains a digitized operating pressure AP1 according to the respective digitized pressure component RP to represent the operating pressure P1, wherein the respective digitized pressure component RP is expressed by a plurality of bits.

The processing unit 33 generates a specific digitized pressure level RA1 of the combination form B1 according to the signal S1, wherein the respective digitized pressure component PC generated at the specific time T11 forms the specific digitized pressure level RA1. The processing unit 33, according to the specific digitized pressure level RA1, makes a first decision that the combination form B1 is in the pressure arrangement state CA1, causes the display unit 31 to use the selection tool L1 to select the position target DA1 from the plurality of position targets D01, D02, D03, D04 . . . and D12, and generates the input information Q1.

The pressure sensing unit 32 includes or is a pressure sensing panel 320. The pressure sensing panel 320 includes a pressure sensing array 321 having a pressure sensing area 321A, and each the at least one press-button point A11 is independently located in the pressure sensing area 321A. The display unit 31 includes or is a display panel 310, wherein the display panel 310 and the pressure sensing panel 320 match each other, and constitute a touch screen 41. For instance, the pressure sensing panel 320 is disposed on the display panel 310; the pressure sensing array 321 is transparent; and the pressure sensing unit 32 has the at least one press-button point A11.

The plurality of position targets D01, D02, D03, D04 . . . and D12 are respectively marked by a plurality of symbols F01, F02, F03, F04 . . . and F12, and are respectively represented by a plurality of codes K01, K02, K03, K04 . . . and K12 respectively representing the plurality of pressure arrangement states C01, C02, C03, C04 . . . and C12, wherein the input information Q1 is the same as or is one of the plurality of codes K01, K02, K03, K04 . . . and K12. In some embodiments, the plurality of pressure arrangement states C01, C02, C03, C04 . . . and C12 are respectively have the plurality of codes K01, K02, K03, K04 . . . and K12. At a starting instant the operating pressure P1 is just to be released, the combination form B1 is in the pressure arrangement state CA1, and the pressure sensing unit 32 generates the signal S1. The processing unit 33 detects the starting instant through the pressure sensing unit 32 to generate the input information Q1. For instance, the processing unit 33 presets the plurality of codes K01, K02, K03, K04 . . . and K12.

In some embodiments, the plurality of position targets D01, D02, D03, D04 . . . and D12 further include a position target DA2 different from the position target DA1, wherein the position target DA2 indicates the pressure arrangement state CA2. For instance, the position target DA2 is the position target D02. When the combination form B2 is in the pressure arrangement state CA2, the pressure sensing unit 32 generates a signal S2. The combination form B2 includes the integer N12 and the pressure level P12, wherein the integer N12 is equal to the respective press-button point count NA of the pressure arrangement state CA2, and the pressure level P12 is in the respective pressure range PR of the pressure arrangement state CA2.

The processing unit 33, according to the signal S2, makes a second decision that the combination form B2 is in the pressure arrangement state CA2, and causes the display unit 31 to use the selection tool L1 to select the position target DA2 from the plurality of position targets D01, D02, D03, D04 . . . and D12. For instance, the display unit 31 displays the selection tool L1, and uses the selection tool L1 to mark the position target DA2. For instance, the at least one press-button point A11 has the count N1 and operating pressure P1, and exists the plurality of pressure arrangement states C01, C02, C03, C04 . . . and C12; when the at least one press-button point A11 is in the pressure arrangement state CA1, the combination form B1 is in the pressure arrangement state CA1; and when the at least one press-button point A11 is in the pressure arrangement state CA2, the combination form B2 is in the pressure arrangement state CA2.

In some embodiments, the plurality of pressure arrangement states C01, C02, C03, C04 . . . and C12 and the plurality of position targets D01, D02, D03, D04 . . . and D12 have a one-to-one correspondence relationship therebetween; and the plurality of pressure arrangement states C01, C02, C03, C04 . . . and C12 are arranged according to a predetermined arrangement order. When the count N1 of the at least one press-button point A11 is changed from the integer N12 to the integer N11 and the operating pressure P1 is changed from the pressure level P12 to the pressure level P11, the combination BA of the count N1 of the at least one press-button point A11 and the operating pressure P1 is changed from the combination form B2 to the combination form B1, and the selection tool L1 is moved from the position target DA2 to the position target DA1. For instance, the operating pressure P1 is just to be released at the specific time T11 (or the starting instant), and the pressure level P11 is a just-to-be-released pressure level.

In some embodiments, the at least one press-button point A11 has the count N1 and the operating pressure P1. When the count N1 of the at least one press-button point A11 is greater than 1, the operating pressure P1 includes a plurality of pressure components, and is a pressure combination of the plurality of pressure components. For instance, the count N1 of the at least one press-button point A11 is equal to 3; the at least one press-button point A11 includes three press-button points A11, A12 and A13; the operating pressure P1 includes three pressure components P1A, P1B and P1C respectively located at the three press-button points A11, A12 and A13, and is a pressure combination of the three pressure components P1A, P1B and P1C. For instance, the three pressure components P1A, P1B and P1C are separate, and are three press receiving points. The respective pressure component PC of the operating pressure P1 at the press-button point A11 is the pressure component P1A; the respective pressure component PC of the operating pressure P1 at the press-button point A12 is the pressure component P1B; and the respective pressure component PC of the operating pressure P1 at the press-button point A13 is the pressure component P1C. For instance, when the count N1 of the at least one press-button point A11 is greater than 1, each of the pressure levels P11 and P12 is a combination pressure level.

In some embodiments, when the count N1 of the at least one press-button point A11 is greater than 1, the digitized operating pressure AP1 includes a plurality of digitized pressure components, and is a component sum of the plurality of digitized pressure components. For instance, the processing unit 33 digitizes the three pressure components P1A, P1B and P1C to respectively generate three digitized pressure components APIA, AP1B and AP1C, and sets the digitized operating pressure AP1 to be equal a component sum of the three digitized pressure components APIA, AP1B and AP1C. For instance, the respective digitized pressure component RP of the operating pressure P1 at the press-button point A11 is the digitized pressure component APIA; the respective digitized pressure component RP of the operating pressure P1 at the press-button point A12 is the digitized pressure component AP1B; and the respective digitized pressure component RP of the operating pressure P1 at the press-button point A13 is the digitized pressure component AP1C. For instance, when the count N1 of the at least one press-button point A11 is equal to 3, the specific digitized pressure level RA1 generated at the specific time T11 is equal to a level sum of the three digitized pressure components APIA, AP1B and AP1C generated at the specific time T11.

The processing unit 33 causes the information input device 30 to be operated in one of a plurality of operating modes according to an input instruction U1, wherein the plurality of operating modes include three operating modes M1, M2 and M3. In some embodiments, when the information input device 30 is operated in the operating mode M1, the information input device 30 includes the following features: the respective press-button point count NA of each of the plurality of pressure arrangement states C01, C02, C03, C04 . . . and C12 is equal to 1; the processing unit 33 causes the plurality of position targets D01, D02, D03, D04 . . . and D12 to be arranged in a linear target array on the display unit 31; and the plurality of pressure ranges of the plurality of pressure arrangement states C01, C02, C03, C04 . . . and C12 are mutually independent.

When the information input device 30 is operated in the operating mode M2, the information input device 30 includes the following features: the respective press-button point count NA of each of the plurality of pressure arrangement states C01, C02, C03, C04 . . . and C12 is greater than or equal to 1; the processing unit 33 causes the plurality of position targets D01, D02, D03, D04 . . . and D12 to be arranged in a first plurality of linear target arrays on the display unit 31; and the plurality of pressure ranges of the plurality of pressure arrangement states C01, C02, C03, C04 . . . and C12 are mutually independent.

In some embodiments, when the information input device 30 is operated in the operating mode M3, the information input device 30 includes the following features. The respective press-button point count NA of each of the plurality of pressure arrangement states C01, C02, C03, C04 . . . and C12 is greater than or equal to 1. The plurality of pressure arrangement states C01, C02, C03, C04 . . . and C12 are divided into a plurality of state groups to cause the plurality of position targets D01, D02, D03, D04 . . . and D12 to be correspondingly divided into a plurality of target groups, wherein each of the plurality of target groups includes a plurality of target members having a specific count, and each of the plurality of state groups includes a plurality of state members having the specific count, and has a respective group press-button point count and a respective group pressure range.

When the information input device 30 is operated in the operating mode M3, the information input device 30 further includes the following features. The respective group pressure range of each state group is independent, and the plurality of state groups includes a specific state group including the pressure arrangement state CAL A respective press-button point count NA of each of the plurality of state members of the each state group is equal to the respective group press-button point count of the each state group, and a respective pressure range PR of each of the plurality of state members of the each state group is equal to the respective group pressure range of the each state group. The processing unit 33 causes the plurality of target groups to be arranged in a second plurality of linear target arrays on the display unit 31.

When the information input device 30 is operated in the operating mode M3, the information input device 30 further includes the following features. Each of the plurality of pressure arrangement states C01, C02, C03, C04 . . . and C12 further has a respective detention-time range TR. When the combination form B1 is in the specific state group, the combination form B1 has a state detention time for the specific state group, wherein the state detention time is a cumulative time that the operating pressure P1 has fallen within the respective group pressure range of the specific state group. When the combination form B1 is in the pressure arrangement state CA1, the state detention time is in the respective detention-time range TR of the pressure arrangement state CAL

In some embodiments, the processing unit 33 stores the input information Q1. The processing unit 33 performs one of a dial operation and an information transmission operation according to the input information Q1. In some embodiments, the pressure sensing unit 32 further includes a function trigger point (not shown). After generating the input information Q1, the processing unit 33 enables the function trigger point. The pressure sensing unit 32 senses the function trigger point and an operating pressure formed at the function trigger point to generate a function signal. The processing unit 33 performs one of a dial operation and an information transmission operation according to the function signal and the input information Q1.

In some embodiments, after generating the input information Q1, the processing unit 33 detects an idle duration of the pressure sensing unit 32 through the pressure sensing unit 32, wherein the idle duration is the duration that a press receiving point count (or the count N1) of the pressure sensing unit 32 is equal to zero. The processing unit 33, by comparing the idle duration with a threshold duration, decides whether to perform one of the dial operation and the information transmission operation according to the input information Q1. For instance, when the idle duration is shorter than the threshold duration, the information input device 30 continues to generate an additional input information; and when the idle duration is longer than the threshold duration, the information input device 30 performs one of the dial operation and the information transmission operation according to the input information Q1.

In various embodiments provided according to the illustrations in FIG. 3, an information input device 30 includes a pressure sensing unit 32 and a processing unit 33 coupled to the pressure sensing unit 32. The pressure sensing unit 32 senses at least one press-button point A11 and an operating pressure P1 formed at the at least one press-button point A11, and generates a signal S1 under a condition that a combination form B1 of a count N1 of the at least one press-button point A11 and the operating pressure P1 is in a pressure arrangement state CA1, wherein the operating pressure P1 has a respective pressure component PC at each the at least one press-button point A11. The processing unit 33 digitizes the respective pressure component PC through the pressure sensing unit 32 to correspondingly generate a respective digitized pressure component RP expressed by a plurality of bits to obtain a specific digitized pressure level RA1 for the operating pressure P1, and generates according to the signal S1 an input information Q1 representing the pressure arrangement state CAL

In some embodiments, the information input device 30 further includes a display unit 31. A combination BA of the count N1 of the at least one press-button point A11 and the operating pressure P1 exists a plurality of pressure arrangement states C01, C02, C03, C04 . . . and C12, wherein the plurality of pressure arrangement states C01, C02, C03, C04 . . . and C12 are predetermined, and include the pressure arrangement state CAL For instance, the pressure arrangement state CA1 is the pressure arrangement state C04. The display unit 31 is coupled to the processing unit 33, and provides a selection tool L1 and a plurality of position targets D01, D02, D03, D04 . . . and D12 associated with the selection tool L1, wherein the plurality of position targets D01, D02, D03, D04 . . . and D12 are predetermined, and respectively indicate the plurality of pressure arrangement states C01, C02, C03, C04 . . . and C12, and include a position target DA1 indicating the pressure arrangement state CAL For instance, the position target DA1 is the position target D04.

The processing unit 33, according to the signal S1, makes a first decision that the combination form B1 is in the pressure arrangement state CA1, and causes the display unit 31 to use the selection tool L1 to select the position target DA1 from the plurality of position targets D01, D02, D03, D04 . . . and D12. The plurality of pressure arrangement states C01, C02, C03, C04 . . . and C12 are respectively represented by a plurality of codes K01, K02, K03, K04 . . . and K12, which includes a code KA1 representing the pressure arrangement state CA1. For instance, the code KA1 is the code K04. At a starting instant (or the specific time T11) the operating pressure P1 is just to be released, the combination form B1 is in the pressure arrangement state CA1, and the pressure sensing unit 32 generates the signal S1. The processing unit 33 detects the starting instant through the pressure sensing unit 32 to generate the input information Q1. For instance, the input information Q1 is the same as or is the code KA1.

In various embodiments provided according to the illustrations in FIG. 3, an information input method includes the following steps. At least one press-button point A11 and an operating pressure P1 formed at the at least one press-button point A11 are sensed, wherein the operating pressure P1 has a respective pressure component PC at each the at least one press-button point A11. The respective pressure component PC is digitized to correspondingly generate a respective digitized pressure component RP expressed by a plurality of bits to obtain a specific digitized pressure level RA1 for the operating pressure P1. A signal S1 is generated under a condition that a combination form B1 of a count N1 of the at least one press-button point A11 and the operating pressure P1 is in a pressure arrangement state CA1. An input information Q1 representing the pressure arrangement state CA1 is generated according to the signal S1.

In some embodiments, a combination BA of the count N1 of the at least one press-button point A11 and the operating pressure P1 exists a plurality of pressure arrangement states C01, C02, C03, C04 . . . and C12. Each of the plurality of pressure arrangement states C01, C02, C03, C04 . . . and C12 has a respective press-button point count NA and a respective pressure range PR; and the plurality of pressure arrangement states C01, C02, C03, C04 . . . and C12 are predetermined, and include the pressure arrangement state CA1 and a pressure arrangement state CA2 different from the pressure arrangement state CA1.

The count N11 of the at least one press-button point A11 is equal to an integer N11 at a specific time T11, and is equal to an integer N12 at a specific time T12 different from the specific time T11. The operating pressure P1 is equal to a pressure level P11 at the specific time T11, and is equal to a pressure level P12 at the specific time T12. The combination form B1 includes the integer N11 and the pressure level P11, wherein the integer N11 is equal to the respective press-button point count NA of the pressure arrangement state CA1, and the pressure level P11 is in the respective pressure range PR of the pressure arrangement state CA1. At a starting instant the operating pressure P1 is just to be released, the combination form B1 is in the pressure arrangement state CA1, and the signal S1 is generated.

In some embodiments, the information input method further includes following steps. A selection tool L1 and a plurality of position targets D01, D02, D03, D04 . . . and D12 associated with the selection tool L1 are provided, wherein the plurality of position targets D01, D02, D03, D04 . . . and D12 includes a position target DA1 and a position target DA2 different from the position target DA1. According to the signal S1, a first decision is made that the combination form B1 is in the pressure arrangement state CA1, and the selection tool L1 is used to select the position target DA1 from the plurality of position targets D01, D02, D03, D04 . . . and D12.

The information input method further includes following steps. When a combination form B2 of the count N1 of the at least one press-button point A11 and the operating pressure P1 is in the pressure arrangement state CA2, a signal S2 is generated, wherein the combination form B2 includes the integer N12 and the pressure level P12, the integer N12 is equal to the respective press-button point count NA of the pressure arrangement state CA2, and the pressure level P12 is in the respective pressure range PA of the pressure arrangement state CA2. According to the signal S2, a second decision is made that the combination form B2 is in the pressure arrangement state CA2, and the selection tool L1 is used to select the position target DA2 from the plurality of position targets D01, D02, D03, D04 . . . and D12, wherein the position target DA2 indicates the pressure arrangement state CA2.

In various embodiments provided according to the illustrations in FIG. 3, an information input device 30 includes a display unit 31, a pressure sensing unit 32 and a processing unit 33. The pressure sensing unit 32 senses an operating pressure P1 at a at least one press-button point A11, and generates a signal S1 of the at least one press-button point A11 in a pressure arrangement state CA1. The display unit 31 provides a selection tool L1 and a position target DA1 indicating the pressure arrangement state CAL The processing unit 33, according to the signal S1, causes the selection tool L1 to select the position target DA1, and generates an input information Q1 representing the pressure arrangement state CA1.

In some embodiments, the pressure sensing unit 32 generates a signal S2 in a pressure arrangement state CA2 different from the pressure arrangement state CAL The display unit 31 provides a position target DA2 indicating the pressure arrangement state CA2. The operating pressure P1 changes with time. The at least one press-button point A11 has a count N1 changing with the time. The operating pressure P1 has a specific pressure level P11 in a specific one of a plurality of pressure ranges. Each the at least one press-button point A11 has a respective pressure component PC. The processing unit 33 digitizes the respective pressure component PC through the pressure sensing unit 32 to correspondingly generate a respective digitized pressure component RP expressed by a plurality of bits to obtain a specific digitized pressure level RA1 for the operating pressure P1. The processing unit 33, according to the specific digitized pressure level RA1, causes the selection tool L1 to select the position target DA1, and generates the input information Q1.

In some embodiments, the position targets DA1 and DA2 are respectively marked by a first symbol (such as F04) and a second symbol (such as F02), and are respectively represented by a first code (such as K04) and a second code (such as K02) respectively representing the pressure arrangement states CA1 and CA2, wherein the input information Q1 is one of the first and the second codes (such as K04 and K02). When the count N1 of the at least one press-button point A11 is greater than 1, the operating pressure P1 is a pressure combination of the respective pressure component PC and the specific digitized pressure level RA1 is a level sum of the respective digitized pressure component RP at a specific time T11. The processing unit 33 causes the information input device 30 to be operated in one of a plurality of operating modes according to an input instruction U1, wherein the plurality of operating modes include three operating modes M1, M2 and M3.

In some embodiments, when the information input device 30 is operated in the operating mode M1, the information input device 30 includes the following features: the at least one press-button point A11 has a count N1 equal to 1; the processing unit 33 causes the position targets DA1 and DA2 and at least a position target (such as D03) to be arranged in a linear target array on the display unit 31; and the plurality of pressure arrangement states (such as CA1, CA2 and C03) are mutually independent. When the information input device 30 is operated in the operating mode M2, the information input device 30 includes the following features: the at least one press-button point A11 has a count N1 greater than or equal to 1; the processing unit 33 causes the position targets DA1 and DA2 and at least a position target (such as D03) to be arranged in a plurality of linear target arrays on the display unit 31; and the plurality of pressure arrangement states (such as CA1, CA2 and C03) are mutually independent.

In some embodiments, when the information input device 30 is operated in the operating mode M3, the information input device 30 includes the following features. The at least one press-button point A11 has a count A11 greater than or equal to 1. The pressure arrangement states CA1 and CA2 and at least two pressure arrangement states (such as C01 and C03) are divided into a plurality of state groups to cause the plurality of position targets to be correspondingly divided into a plurality of target groups, each of which has a plurality of target members having a specific count, and each of the plurality of state groups has a plurality of state members having the specific count, and has a respective group press-button point count and a respective group pressure range. The at least one press-button point count has a same count throughout the each state group, and the respective pressure range of each of the plurality of state members is equal to the respective group pressure range throughout the each state group. The processing unit 33 causes the plurality of position targets to be arranged in a plurality of linear target arrays on the display unit 31. The operating pressure P1 has a state detention time for the respective group pressure range, wherein the state detention time is a cumulative time that the operating pressure P1 has fallen within the respective group pressure range of one of the plurality of state groups. Each of the plurality of pressure arrangement states further has a respective detention-time range TR to be associated with the state detention time.

In various embodiments provided according to the illustrations in FIG. 3, an information input device 30 includes a pressure sensing unit 32 and a processing unit 33. The pressure sensing unit 32 senses an operating pressure P1 at a at least one press-button point A11, and generating a signal S1 of the at least one press-button point A11 in a pressure arrangement state CA1, wherein the operating pressure P1 has a respective pressure component PC at each the at least one press-button point A11. The processing unit 33 digitizes the respective pressure component PC through the pressure sensing unit 32 to correspondingly generate a respective digitized pressure component RP expressed by a plurality of bits to obtain a specific digitized pressure level RA1 for the operating pressure P1, and generates according to the signal S1 an input information Q1 representing the pressure arrangement state CA1.

In various embodiments provided according to the illustrations in FIG. 3, an information input method includes the following steps. An operating pressure P1 formed at a at least one press-button point A11 is sensed, wherein the operating pressure P1 has a respective pressure component PC at each the at least one press-button point A11. The respective pressure component PC is digitized to correspondingly generate a respective digitized pressure component RP expressed by a plurality of bits. A signal S1 is generated when the at least one press-button point A11 is in a pressure arrangement state CA1. An input information Q1 representing the pressure arrangement state CA1 is generated according to the signal S1.

In some embodiments, at a starting instant, the operating pressure P1 is just to be released. The information input method further includes the following steps. The starting instant is detected to generate the input information Q1. One of a dial operation and an information transmission operation is performed according to the input information Q1.

In some embodiments, the operating pressure P1 changes with time. The at least one press-button point A11 has a count N1 changing with the time. The operating pressure P1 has a specific pressure level P11 in a specific one of a plurality of pressure ranges. The information input method further includes the following steps. A selection tool L1 and a plurality of position targets are provided, wherein the plurality of position targets includes a position target DA1 and a position target DA2 different from the position target DA1. A signal S2 is generated when the at least one press-button point A11 is in a pressure arrangement state CA2 different from the pressure arrangement state CAL When the at least one press-button point A11 is in the pressure arrangement state CA1, the selection tool L1 is caused to select the position target DA1. When the at least one press-button point A11 is in the pressure arrangement state CA2, the selection tool L1 is caused to select the position target DA2.

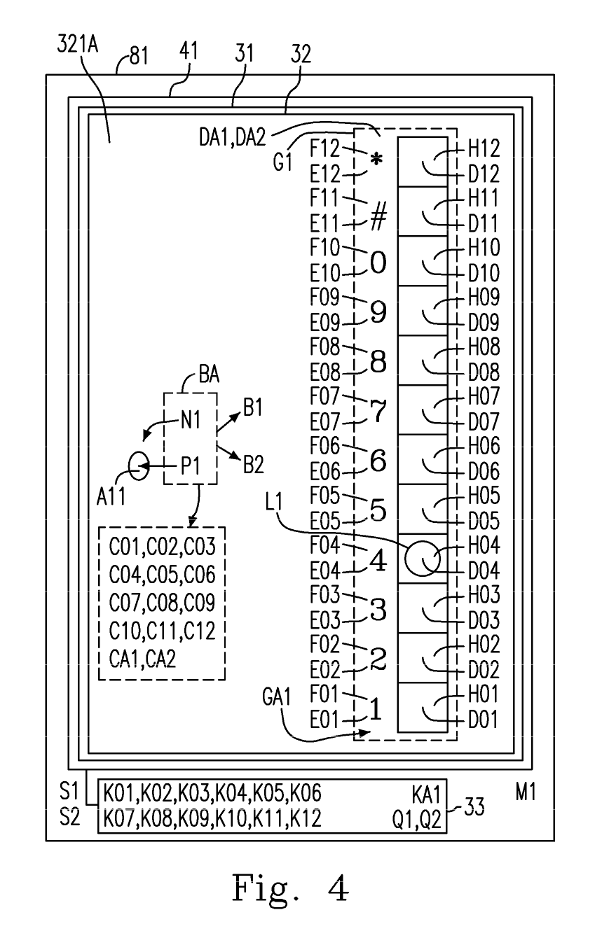

Please refer to FIG. 4, which is a schematic structural diagram showing an information input device 81 according to various embodiments of the present disclosure. Please additionally refer to FIG. 3. The information input device 81 includes a touch screen 41 and a processing unit 33 coupled to the touch screen 41. The structure and the operating method of the information input device 81 are similar to those of the information input device 30. The characteristic features of the information input device 81 are described as follows. The touch screen 41 includes a display unit 31 and a pressure sensing unit 32 coupled to the display unit 31; and the information input device 81 is operated in the operating mode M1.

The right side of the display unit 31 has a specific display area G1, which includes a plurality of position targets D01, D02, D03, D04, D05, D06, D07, D08, D09, D10, D11 and D12, and a plurality of symbol positions E01, E02, E03, E04, E05, E06, E07, E08, E09, E10, E11 and E12 respectively corresponding to the plurality of position targets D01, D02, D03, D04, D05, D06, D07, D08, D09, D10, D11 and D12. For instance, the plurality of symbol positions E01, E02, E03, E04, E05, E06, E07, E08, E09, E10, E11 and E12 are respectively near to or respectively coincide with the plurality of position targets D01, D02, D03, D04, D05, D06, D07, D08, D09, D10, D11 and D12.

The processing unit 33 causes the display unit 31 to display a pressure gauge table GA1 in the specific display area G1. The pressure gauge table GA1 includes a plurality of squares H01, H02, H03, H04, H05, H06, H07, H08, H09, H10, H11 and H12 respectively located at the plurality of position targets D01, D02, D03, D04, D05, D06, D07, D08, D09, D10, D11 and D12, and a plurality of symbols F01, F02, F03, F04, F05, F06, F07, F08, F09, F10, F11 and F12 respectively located at the plurality of symbol positions E01, E02, E03, E04, E05, E06, E07, E08, E09, E10, E11 and E12. For instance, the processing unit 33 causes the plurality of position targets D01, D02, D03, D04, D05, D06, D07, D08, D09, D10, D11 and D12 to be arranged in a first linear target array on the display unit 31; and the plurality of symbols F01, F02, F03, F04, F05, F06, F07, F08, F09, F10, F11 and F12 are “1”, “2”, “3”, “4”, “5”, “6”, “7”, “8”, “9”, “0”, “#” and “*”, respectively.

When the user presses any press-button point A11 in the touch screen 41 to form the operating pressure P1, the pressure sensing unit 32 senses the at least one press-button point A11 and the operating pressure P1 formed at the at least one press-button point A11, wherein the count N1 of the at least one press-button point A11 is equal to 1. The information input device 81, according to the pressure level of the operating pressure P1, causes a selection tool L1 to run to a specific one (such as D02) of the plurality of position targets D01, D02, D03, D04, D05, D06, D07, D08, D09, D10, D11 and D12 corresponding to the pressure level. For instance, the press-button point A11 represents an independent press-button area of the pressure sensing unit 32.

The pressure sensing unit 32 is a pressure sensing panel 320. The pressure sensing panel 320 includes a pressure sensing array 321 having a pressure sensing area 321A, and each the at least one press-button point A11 is independently located in the pressure sensing area 321A. The display unit 31 is a display panel 310, wherein the display panel 310 and the pressure sensing panel 320 match each other, and constitute the touch screen 41.

When the user releases the operating pressure P1 to cause his or her finger to leave the touch screen 41, the information input device 81 cause the selection tool L1 to be at a specific position target (such as DA1) corresponding to a just-to-be-released pressure level of the operating pressure P1, and generates the input information Q1 corresponding to the just-to-be-released pressure level. For instance, the just-to-be-released pressure level is equal to a pressure level of the operating pressure P1 at the starting instant that the operating pressure P1 is just to be released. The user employs the same method to optionally repeat the abovementioned button-press operation to generate an additional input information Q2. When the user wishes to finish the input, the user performs a specific operation to cause the information input device 81 to perform one of a dial operation and an information transmission operation according to the input information Q1 and the optional additional input information Q2. For instance, the specific operation is an idleness operation having an idle duration, a trigger operation of touching a trigger point in the pressure sensing area 321A, or an operation of touching the touch screen 41 more than once, wherein the idle duration is longer than a threshold duration.

In some embodiments, a combination BA of the count N1 of the at least one press-button point A11 and the operating pressure P1 exists a plurality of pressure arrangement states C01, C02, C03, C04, C05, C06, C07, C08, C09, C10, C11 and C12. The plurality of pressure arrangement states C01, C02, C03, C04, C05, C06, C07, C08, C09, C10, C11 and C12 are predetermined, and respectively correspond to the plurality of position targets D01, D02, D03, D04, D05, D06, D07, D08, D09, D10, D11 and D12. The combination BA of the count N1 of the at least one press-button point A11 and the operating pressure P1 is equal to the combination form B1 at a specific time T11, and is equal to a combination form B2 at a specific time T12 earlier than the specific time T11. For instance, the plurality of pressure arrangement states C01, C02, C03, C04, C05, C06, C07, C08, C09, C10, C11 and C12 respectively have twelve pressure ranges (twelve PRs), which are arranged according a pressure level-increasing criterion.

The combination forms B1 and B2 are in the pressure arrangement states CA1 (such as being C04) and CA2 (such as being C02), respectively. When the combination BA is equal to the combination form B1, the processing unit 33 causes the selection tool L1 to run to a specific one DA1 (such as being D04) of the plurality of position targets D01, D02, D03, D04, D05, D06, D07, D08, D09, D10, D11 and D12. When the combination BA is equal to the combination form B2, the processing unit 33 causes the selection tool L1 to run to a specific one DA2 (such as being D02) of the plurality of position targets D01, D02, D03, D04, D05, D06, D07, D08, D09, D10, D11 and D12. For instance, at a starting instant (such as being the specific time T11) the operating pressure P1 is just to be released, the combination form B1 is in the pressure arrangement state CAL For instance, the selection tool L1 passes through the position targets D01, D02 and D03 in turn, and then runs to the position target D04.

In some embodiments, the information input device 81 is a communication device. The pressure sensing unit 32 is transparent, is disposed on the display unit 31, and receives the operating pressure P1. In some embodiments, the input information Q1 is a numerical input information; when the operating pressure P1 is released to release the press-button point A11, the information input device 81 generates the input information Q1 corresponding to the just-to-be-released pressure level; and then the user touches the touch screen 41 more than once to perform the dial operation.

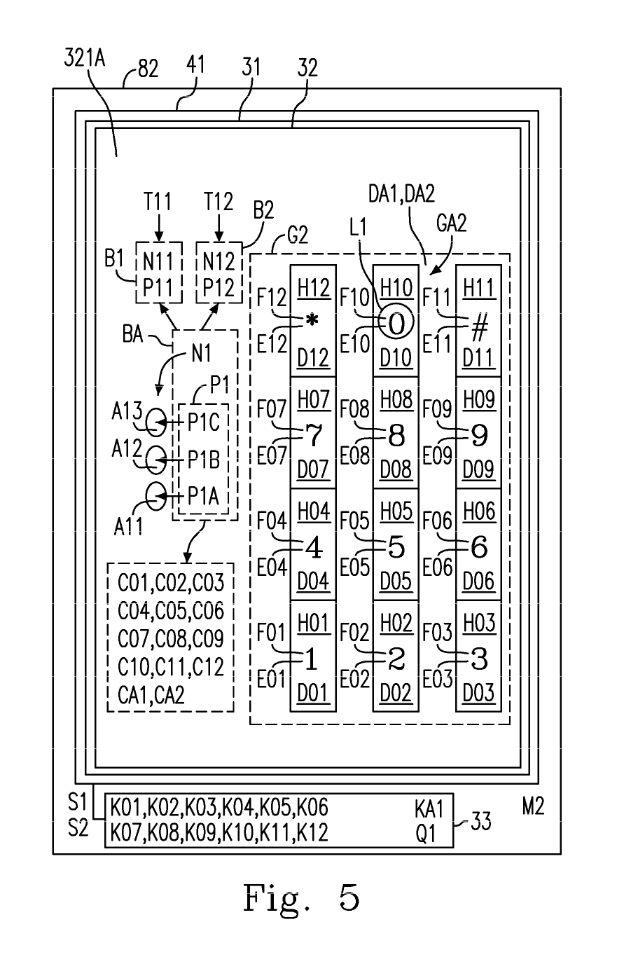

Please refer to FIG. 5, which is a schematic structural diagram showing an information input device 82 according to various embodiments of the present disclosure. Please additionally refer to FIG. 3. The information input device 82 includes a touch screen 41 and a processing unit 33 coupled to the touch screen 41. The structure and the operating method of the information input device 82 are similar to those of the information input device 30. The characteristic features of the information input device 82 are described as follows. The touch screen 41 includes a display unit 31 and a pressure sensing unit 32 coupled to the display unit 31; and the information input device 82 is operated in the operating mode M2. The display unit 31 has a specific display area G2, which includes a plurality of position targets D01, D02, D03, D04, D05, D06, D07, D08, D09, D10, D11 and D12, and a plurality of symbol positions E01, E02, E03, E04, E05, E06, E07, E08, E09, E10, E11 and E12 respectively corresponding to the plurality of position targets D01, D02, D03, D04, D05, D06, D07, D08, D09, D10, D11 and D12.

The processing unit 33 causes the display unit 31 to display a pressure gauge table GA2 in the specific display area G2. The pressure gauge table GA2 includes a plurality of squares H01, H02, H03, H04, H05, H06, H07, H08, H09, H10, H11 and H12 respectively located at the plurality of position targets D01, D02, D03, D04, D05, D06, D07, D08, D09, D10, D11 and D12, and a plurality of symbols F01, F02, F03, F04, F05, F06, F07, F08, F09, F10, F11 and F12 respectively located at the plurality of symbol positions E01, E02, E03, E04, E05, E06, E07, E08, E09, E10, E11 and E12.

For instance, the processing unit 33 causes the plurality of position targets D01, D02, D03, D04, D05, D06, D07, D08, D09, D10, D11 and D12 to be arranged in a first plurality of linear target arrays on the display unit 31; and the plurality of symbols F01, F02, F03, F04, F05, F06, F07, F08, F09, F10, F11 and F12 are “1”, “2”, “3”, “4”, “5”, “6”, “7”, “8”, “9”, “0”, “#” and “*”, respectively. For instance, the first plurality of linear target arrays include a first linear target array, a second linear target array and a third linear target array. The first linear target array includes a plurality of position targets D01, D04, D07 and D12. The second linear target array includes a plurality of position targets D02, D05, D08 and D10. The third linear target array includes a plurality of position targets D03, D06, D09 and D11.

The pressure sensing unit 32 senses the at least one press-button point A11 and the operating pressure P1 formed at the at least one press-button point A11. The count N1 of the at least one press-button point A11 and the operating pressure P1 forms a combination BA; and the count N1 of the at least one press-button point A11 is greater than or equal to 1. The combination BA is equal to a combination form B1 at a specific time T11. In some embodiments, the combination BA is further equal to a combination form B2 at a specific time T12 earlier than the specific time T11.

Under a condition that the combination form B1 is in a pressure arrangement state CA1, the pressure sensing unit 32 generates a signal S1, wherein the pressure arrangement state CA1 is one of the plurality of pressure arrangement states C01, C02, C03, C04, C05, C06, C07, C08, C09, C10, C11 and C12. The plurality of position targets D01, D02, D03, D04, D05, D06, D07, D08, D09, D10, D11 and D12 of the display unit 31 are predetermined, and respectively indicate the plurality of pressure arrangement states C01, C02, C03, C04, C05, C06, C07, C08, C09, C10, C11 and C12. A position target DA1 being one (such as D10) of the plurality of position targets D01, D02, D03, D04, D05, D06, D07, D08, D09, D10, D11 and D12 indicates the pressure arrangement state CA1 (such as being C10).

The plurality of symbols F01, F02, F03, F04, F05, F06, F07, F08, F09, F10, F11 and F12 respectively mark the plurality of pressure arrangement states C01, C02, C03, C04, C05, C06, C07, C08, C09, C10, C11 and C12. The plurality of position targets D01, D02, D03, D04, D05, D06, D07, D08, D09, D10, D11 and D12, the plurality of symbols F01, F02, F03, F04, F05, F06, F07, F08, F09, F10, F11 and F12, or the plurality of pressure arrangement states C01, C02, C03, C04, C05, C06, C07, C08, C09, C10, C11 and C12 are respectively represented by a plurality of codes K01, K02, K03, K04, K05, K06, K07, K08, K09, K10, K11 and K12. A code KA1 being one (such as K10) represents the pressure arrangement state CA1 (such as being C10).

The processing unit 33, according to the signal S1, causes the display unit 31 to use the selection tool L1 to select the position target DA1 from the plurality of position targets D01, D02, D03, D04, D05, D06, D07, D08, D09, D10, D11 and D12, and generates an input information Q1 representing the pressure arrangement state CAL For instance, the input information Q1 is the code KA1. The plurality of pressure arrangement states C01, C02, C03, C04, C05, C06, C07, C08, C09, C10, C11 and C12 respectively have twelve pressure ranges (twelve PRs), which are mutually independent. For instance, at a starting instant (or the specific time T11) the operating pressure P1 is just to be released, the combination form B1 is in the pressure arrangement state CA1.

In some embodiments, when the combination form B2 is in the pressure arrangement state CA2, the pressure sensing unit 32 generates a signal S2. The pressure arrangement state CA2 is one of the plurality of pressure arrangement states C01, C02, C03, C04, C05, C06, C07, C08, C09, C10, C11 and C12, and is different from the pressure arrangement state CAL A position target DA2 being one (such as D05) of the plurality of position targets D01, D02, D03, D04, D05, D06, D07, D08, D09, D10, D11 and D12 indicates the pressure arrangement state CA2 (such as being C05). The processing unit 33, according to the signal S2, causes the display unit 31 to use the selection tool L1 to select the position target DA2 from the plurality of position targets D01, D02, D03, D04, D05, D06, D07, D08, D09, D10, D11 and D12. For instance, the processing unit 33, according to the signal S2, causes the selection tool L1 to run to the position target DA2.

In some embodiments, the user uses a single finger to press a press-button point A11 of the pressure sensing unit 32, or uses two fingers to respectively press two press-button points A11 and A12, or uses three fingers to respectively press three press-button points A11, A12 and A13. The processing unit 33, according to the signal S1, decides that the combination form B1 is in the pressure arrangement state CAL Each of the plurality of pressure arrangement states C01, C02, C03, C04, C05, C06, C07, C08, C09, C10, C11 and C12 has a respective press-button point count NA and a respective pressure range PR. For instance, the processing unit 33, according to the signal S1, decide that the count N1 of the at least one press-button point A11 is equal to an integer N11, and decide that the operating pressure P1 is equal to a pressure level P11. For instance, the pressure level P11 is a just-to-be-released pressure level; and the integer N11 is equal to 2 to indicate that two fingers simultaneously apply forces to form the pressure level P11.

In some embodiments, when the count N1 of the at least one press-button point A11 is greater than 1, the operating pressure P1 includes a plurality of pressure components, and is a pressure combination of the plurality of pressure components. For instance, the count N1 of the at least one press-button point A11 is equal to 3; the at least one press-button point A11 includes three press-button points A11, A12 and A13; the operating pressure P1 includes three pressure components P1A, P1B and P1C respectively located at the three press-button points A11, A12 and A13, and is a pressure combination of the three pressure components P1A, P1B and P1C.

In some embodiments, when the count N1 of the at least one press-button point A11 is greater than 1, the digitized operating pressure AP1 includes a plurality of digitized pressure components, and is a component sum of the plurality of digitized pressure components. For instance, the processing unit 33 digitizes the three pressure components P1A, P1B and P1C to respectively generate three digitized pressure components APIA, AP1B and AP1C, and sets the digitized operating pressure AP1 to be equal a component sum of the three digitized pressure components AP1A, AP1B and AP1C. For instance, when the count N1 of the at least one press-button point A11 is equal to 3, the specific digitized pressure level RA1 generated at the specific time T11 is equal to a level sum of the three digitized pressure components APIA, AP1B and AP1C generated at the specific time T11.

In some embodiments, the plurality of pressure arrangement states C01, C02, C03, C04, C05, C06, C07, C08, C09, C10, C11 and C12 are divided into a plurality of state sets according to a predetermined press-button point count criterion. For instance, the plurality of state sets includes a first state set, a second state set and a third state set. The first state set is used for the single-finger press processing of the information device 82, and include a plurality of pressure arrangement states C01, C04, C07 and C12 respectively corresponding to a plurality of position targets D01, D04, D07 and D12. The respective press-button point count NA of each of the plurality of pressure arrangement states C01, C04, C07 and C12 is equal to 1. The plurality of pressure arrangement states C01, C04, C07 and C12 respectively have four pressure ranges (four PRs), which are arranged according to a pressure level-increasing criterion.

The second state set is used for the simultaneous two-finger press processing of the information device 82, and include a plurality of pressure arrangement states C02, C05, C08 and C10 respectively corresponding to a plurality of position targets D02, D05, D08 and D10. The respective press-button point count NA of each of the plurality of pressure arrangement states C02, C05, C08 and C10 is equal to 2. The plurality of pressure arrangement states C02, C05, C08 and C10 respectively have four pressure ranges (four PRs), which are arranged according to a pressure level-increasing criterion. The third state set is used for the three-finger press processing of the information device 82, and include a plurality of pressure arrangement states C03, C06, C09 and C11 respectively corresponding to a plurality of position targets D03, D06, D09 and D11. The respective press-button point count NA of each of the plurality of pressure arrangement states C03, C06, C09 and C11 is equal to 3. The plurality of pressure arrangement states C03, C06, C09 and C11 respectively have four pressure ranges (four PRs), which are arranged according to a pressure level-increasing criterion.

For instance, by using the single-finger press processing, the information device 82 can generate one of a plurality of codes K01, K04, K07 and K12, wherein the plurality of codes K01, K04, K07 and K12 respectively represent a plurality of symbols F01, F04, F07 and F12 (such as a plurality of symbols “1”, “4”, “7” and “*”). By using the simultaneous two-finger press processing, the information device 82 can generate one of a plurality of codes K02, K05, K08 and K10, wherein the plurality of codes K02, K05, K08 and K10 respectively represent a plurality of symbols F02, F05, F08 and F10 (such as a plurality of symbols “2”, “5”, “8” and “0”). By using the three-finger press processing, the information device 82 can generate one of a plurality of codes K03, K06, K09 and K11, wherein the plurality of codes K03, K06, K09 and K11 respectively represent a plurality of symbols F03, F06, F09 and F11 (such as a plurality of symbols “3”, “6”, “9” and “#”).

In some embodiments, the processing unit 33, according to the signal S1, decides that the count N1 of the at least one press-button point A11 is equal to the integer N11, and thus decides that the combination form B1 is in a specific one of the plurality of state sets, wherein the specific state set corresponds to the integer N11, and includes the pressure arrangement state CA1. The processing unit 33, according to the signal S1, decides that the pressure level P11 is in a respective pressure range PR of the pressure arrangement state CA1, thereby deciding that the combination form B1 is in the pressure arrangement state CA1. The processing unit 33 detects the starting instant through the pressure sensing to decide that the operating pressure P1 is just to be released, and generates the input information Q1 according to the decision that the combination form B1 is in the pressure arrangement state CA1, wherein the input information Q1 is the code KA1.

In some embodiments, the user presses any place in the touch screen 41. The touch screen 41 detects the user press to generate a first detection signal, wherein the user press is applied to the at least one press-button point A11, and forms the operating pressure P1 at the at least one press-button point A11. The processing unit 33, according to the first detection signal, decides that the user press is a single-finger press, a simultaneous two-finger press, or a simultaneous three-finger press. The operating pressure P1 has a pressure level, which is a combination pressure level when the count N1 of the at least one press-button point A11 is greater than 1. When the user press is the simultaneous two-finger press, the processing unit 33, according to the first detection signal, decides that the pressure level is a first pressure level corresponding to the symbol F02, a second pressure level corresponding to the symbol F05, a third pressure level corresponding to the symbol F08, or a fourth pressure level corresponding to the symbol F10, thereby generating the input information Q1, which is one of the plurality of codes K02, K05, K08 and K10.

In some embodiments, when the user press is the single-finger press, the input information Q1 is one of the plurality of codes K01, K04, K07 and K12. When the user press is the simultaneous two-finger press, the input information Q1 is one of the plurality of codes K02, K05, K08 and K10. When the user press is the simultaneous three-finger press, the input information Q1 is one of the plurality of codes K03, K06, K09 and K11. For instance, the information input device 82 is a communication device. The input information Q1 is a numerical input information; when the operating pressure P1 is released to release the at least one press-button point A11, the information input device 81 generates the input information Q1 corresponding to the just-to-be-released pressure level; and then the user performs a specific operation to perform a dial operation. For instance, the specific operation is one of touching the touch screen 41 more than once.

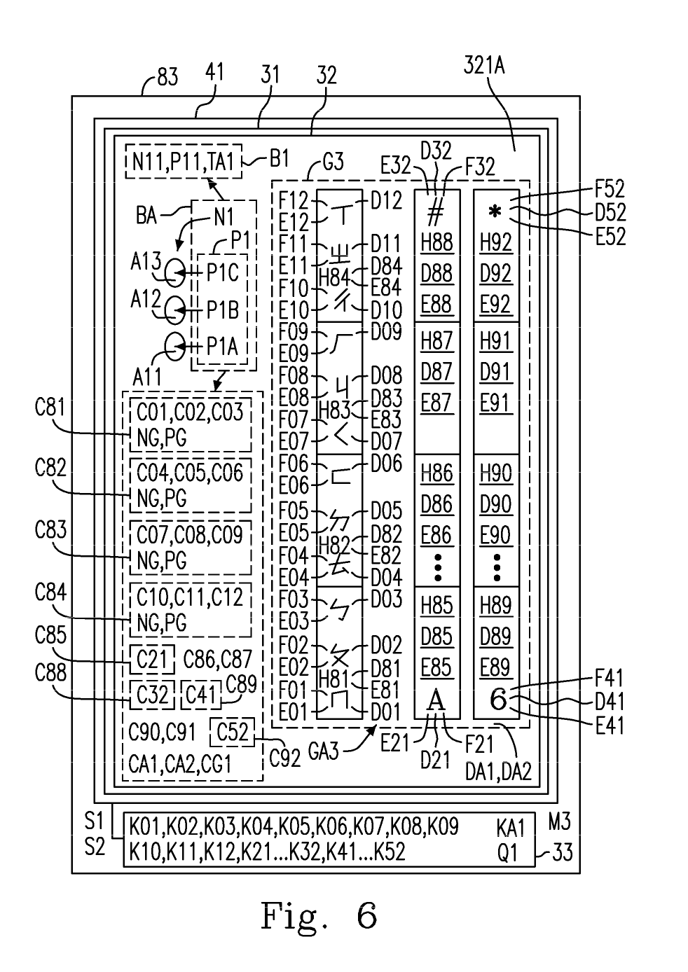

Please refer to FIG. 6, which is a schematic structural diagram showing an information input device 83 according to various embodiments of the present disclosure. Please additionally refer to FIG. 3. The information input device 83 includes a touch screen 41 and a processing unit 33 coupled to the touch screen 41. The structure and the operating method of the information input device 83 are similar to those of the information input devices 30 and 82. The characteristic features of the information input device 83 are described as follows. The touch screen 41 includes a display unit 31 and a pressure sensing unit 32 coupled to the display unit 31; and the information input device 83 is operated in the operating mode M3.

The display unit 31 has a specific display area G3, which includes a plurality of position targets D01, D02, D03, D04, D05, D06, D07, D08, D09, D10, D11, D12, D21 . . . D32, D41 . . . and D52, and a plurality of symbol positions E01, E02, E03, E04, E05, E06, E07, E08, E09, E10, E11, E12, E21 . . . E32, E41 . . . and E52 respectively corresponding to the plurality of position targets D01, D02, D03, D04, D05, D06, D07, D08, D09, D10, D11, D12, D21 . . . D32, D41 . . . and D52. For instance, the plurality of symbol positions E01, E02, E03, E04, E05, E06, E07, E08, E09, E10, E11, E12, E21 . . . E32, E41 . . . and E52 are respectively near to or respectively coincide with the plurality of position targets D01, D02, D03, D04, D05, D06, D07, D08, D09, D10, D11, D12, D21 . . . D32, D41 . . . and D52.

The plurality of position targets D01, D02, D03, D04, D05, D06, D07, D08, D09, D10, D11, D12, D21 . . . D32, D41 . . . and D52 are divided into a plurality of target groups D81, D82, D83, D84, D85, D86, D87, D88, D89, D90, D91 and D92, which respectively have a plurality of group position E81, E82, E83, E84, E85, E86, E87, E88, E89, E90, E91 and E92.

The processing unit 33 causes the display unit 31 to display a pressure gauge table GA3 in the specific display area G3. The pressure gauge table GA3 includes a plurality of squares H81, H82, H83, H84, H85, H86, H87, H88, H89, H90, H91 and H92 respectively located at the plurality of group position E81, E82, E83, E84, E85, E86, E87, E88, E89, E90, E91 and E92, and a plurality of symbols F01, F02, F03, F04, F05, F06, F07, F08, F09, F10, F11, F12, F21 . . . F32, F41 . . . and F52 respectively located at the plurality of symbol positions E01, E02, E03, E04, E05, E06, E07, E08, E09, E10, E11, E12, E21 . . . E32, E41 . . . and E52.

For instance, the processing unit 33 causes the plurality of target groups D81, D82, D83, D84, D85, D86, D87, D88, D89, D90, D91 and D92 to be arranged in a second plurality of linear target arrays on the display unit 31. The second plurality of linear target arrays include a fourth linear target array, a fifth linear target array and a sixth linear target array. The fourth linear target array includes a plurality of target groups D81, D82, D83 and D84. The fifth linear target array includes a plurality of target groups D85, D86, D87 and D88. The sixth linear target array includes a plurality of target groups D89, D90, D91 and D92.

In some embodiments, the pressure sensing unit 32 senses the at least one press-button point A11 and the operating pressure P1 formed at the at least one press-button point A11. A combination BA of the count N1 of the at least one press-button point A11 and the operating pressure P1 exists a plurality of pressure arrangement states C01, C02, C03, C04, C05, C06, C07, C08, C09, C10, C11, C12, C21 . . . C32, C41 . . . and C52, which respectively correspond to the plurality of position targets D01, D02, D03, D04, D05, D06, D07, D08, D09, D10, D11, D12, D21 . . . D32, D41 . . . and D52, and includes a pressure arrangement state CA1 and a pressure arrangement state CA2 different from the pressure arrangement state CAL The combination BA of the count N1 of the at least one press-button point A11 and the operating pressure P1 is equal to a combination form B1 at a specific time T11, and is equal to a combination form B2 at a specific time T12 earlier than the specific time T11.

Under a condition that the combination form B1 is in a pressure arrangement state CA1, the pressure sensing unit 32 generates a signal S1. The processing unit 33, according to the signal S1, generates an input information Q1 representing the pressure arrangement state CA1. Each of the plurality of pressure arrangement states C01, C02, C03, C04, C05, C06, C07, C08, C09, C10, C11, C12, C21 . . . C32, C41 . . . and C52 has a respective press-button point count NA and a respective pressure range PR, wherein the respective press-button point count NA is greater than or equal to 1. For instance, the processing unit 33, according to the signal S1, decides that the count N1 of the at least one press-button point A11 is equal to an integer N11 and the operating pressure P1 is equal to a pressure level P11. For instance, the pressure level P11 is a just-to-be-released pressure level, and the integer N11 is equal to 1 to indicate a single-finger force applying.

The plurality of pressure arrangement states C01, C02, C03, C04, C05, C06, C07, C08, C09, C10, C11, C12, C21 . . . C32, C41 . . . and C52 are divided into a plurality of state groups C81, C82, C83, C84, C85, C86, C87, C88, C89, C90, C91 and C92 to cause the plurality of position targets D01, D02, D03, D04, D05, D06, D07, D08, D09, D10, D11, D12, D21 . . . D32, D41 . . . and D52 to be correspondingly divided into a plurality of target groups D81, D82, D83, D84, D85, D86, D87, D88, D89, D90, D91 and D92.

Each of the plurality of target groups D81, D82, D83, D84, D85, D86, D87, D88, D89, D90, D91 and D92 includes a plurality of target members having a specific count, and each of the plurality of state groups C81, C82, C83, C84, C85, C86, C87, C88, C89, C90, C91 and C92 includes a plurality of state members having the specific count, and has a respective group press-button point count NG and a respective group pressure range PG to cause the plurality of state groups C81, C82, C83, C84, C85, C86, C87, C88, C89, C90, C91 and C92 to respective have a plurality of group pressure ranges, which are mutually independent. The plurality of state groups C81, C82, C83, C84, C85, C86, C87, C88, C89, C90, C91 and C92 includes a specific state group CG1, which includes the pressure arrangement state CA1.

The plurality of pressure arrangement states C01, C02, C03, C04, C05, C06, C07, C08, C09, C10, C11, C12, C21 . . . C32, C41 . . . and C52 are respectively represented by a plurality of codes K01, K02, K03, K04, K05, K06, K07, K08, K09, K10, K11, K12, K21 . . . K32, K41 . . . and K52. The pressure arrangement state CA1 is represented by a corresponding one KA1 of the plurality of codes K01, K02, K03, K04, K05, K06, K07, K08, K09, K10, K11, K12, K21 . . . K32, K41 . . . and K52.

A respective press-button point count NA of each of the plurality of state members of the each state group is equal to the respective group press-button point count NG of the each state group, and a respective pressure range PR of each of the plurality of state members of the each state group is equal to the respective group pressure range PG of the each state group. The processing unit 33 causes the plurality of target groups D81, D82, D83, D84, D85, D86, D87, D88, D89, D90, D91 and D92 to be arranged in a second plurality of linear target arrays on the display unit 31.

A respective press-button point count NA of each of the plurality of state members of the each state group is equal to the respective group press-button point count NG of the each state group, and a respective pressure range PR of each of the plurality of state members of the each state group is equal to the respective group pressure range PG of the each state group. The processing unit 33 causes the plurality of target groups D81, D82, D83, D84, D85, D86, D87, D88, D89, D90, D91 and D92 to be arranged in the second plurality of linear target arrays on the display unit 31. Each of the plurality of pressure arrangement states C01, C02, C03, C04, C05, C06, C07, C08, C09, C10, C11, C12, C21 . . . C32, C41 . . . and C52 further has a respective detention-time range TR. When the combination form B1 is in the specific state group CG1, the combination form B1 has a state detention time TA1 for the specific state group CG1, wherein the state detention time TA1 is a cumulative time that the operating pressure P1 has fallen within the respective group pressure range PG of the specific state group CG1. When the combination form B1 is in the pressure arrangement state CA1, the state detention time TA1 is in the respective detention-time range TR of the pressure arrangement state CA1.

In some embodiments, the plurality of state groups C81, C82, C83, C84, C85, C86, C87, C88, C89, C90, C91 and C92 are divided into a plurality of state sets according to a predetermined press-button point count criterion. For instance, the plurality of state sets includes a fourth state set, a fifth state set and a sixth state set. The fourth state set is used for the single-finger press processing of the information device 83, and include a plurality of state groups C81, C82, C83 and C84 respectively corresponding to a plurality of target groups D81, D82, D83 and D84. The respective group press-button point count NG of each of the plurality of state groups C81, C82, C83 and C84 is equal to 1.

The fifth state set is used for a simultaneous two-finger press processing of the information device 83, and include a plurality of state groups C85, C86, C87 and C88 respectively corresponding to a plurality of target groups D85, D86, D87 and D88. The respective group press-button point count NG of each of the plurality of state groups C85, C86, C87 and C88 is equal to 2. The sixth state set is used for a simultaneous three-finger press processing of the information device 83, and include a plurality of state groups C89, C90, C91 and C92 respectively corresponding to a plurality of target groups D89, D90, D91 and D92. The respective group press-button point count NG of each of the plurality of state groups C89, C90, C91 and C92 is equal to 3.

In some embodiments, the processing unit 33, according to the signal S1, decides that the count N1 of the at least one press-button point A11 is equal to an integer N11, and thus decides that the combination form B1 is in a specific one of the plurality of state sets. The specific state set corresponds to the integer N11, and includes the specific state group CG1, which includes the pressure arrangement state CAL The processing unit 33, according to the signal S1, decides that the pressure level P11 is in the respective group pressure range PG of the specific state group CG1.

When the pressure level P11 is in the respective pressure arrange PG of the specific state group CG1, the processing unit 33 determines the state detention time TA1 according to the signal S1, and according to the state detention time TA1 and a plurality of detention-time ranges (three TRs) in the specific state group CG1, decides that the combination form B1 is in the pressure arrangement state CAL For instance, the respective three detention-time ranges (three TRs) in the specific state group CG1 are mutually independent. For instance, the respective detention-time range TR includes at least a time sub-range. At the starting instant (being the specific time T11) that the operating pressure P1 is just to be released, the combination form B1 is in the pressure arrangement state CAL The processing unit 33 detects the starting instant, and generates the input information Q1 according to the decision that the combination form B1 is in the pressure arrangement state CA1, wherein the input information Q1 is the same as or is the code KA1.

In some embodiments, the user presses any place in the touch screen 41. The touch screen 41 detects the user press to generate a second detection signal, wherein the user press is applied to the at least one press-button point A11, and forms the operating pressure P1 at the at least one press-button point A11. The processing unit 33, according to the second detection signal, decides that the user press is a single-finger press, a simultaneous two-finger press, or a simultaneous three-finger press. The operating pressure P1 has a pressure level, which is a combination pressure level when the count N1 of the at least one press-button point A11 is greater than 1. When the user press is the single-finger press, the processing unit 33, according to the second detection signal, decides that the pressure level is a fifth pressure level corresponding to the state group C81, a sixth pressure level corresponding to the state group C82, a seventh pressure level corresponding to the state group C83, or an eighth pressure level corresponding to the state group C84.

When the pressure level is in the respective group pressure range PG of the state group C81, the processing unit decides that the specific state group CG1 is the state group C81, determines the state detention time TA1 according to the second detection signal (or signal S1), and according to the state detention time TA1 and the respective three detention-time ranges (three TRs) included in the state group C81, decides that the combination form B1 is in the pressure arrangement state CA1 (such as being C03), thereby generating the input information Q1, which is one (such as being K03) of the plurality of codes K01, K02 and K03.

In some embodiments, the processing unit 33 selects a corresponding mandarin phonetic symbol, an English letter or a digit according to the length of the state detention time TA1. The respective detention-time range TR of the pressure arrange state C01 includes a sub-range between 0 second and 3 seconds and a sub-range between 9 seconds and 12 seconds, and corresponds to a symbol “ [symbol] ”. The respective detention-time range TR of the pressure arrange state C02 includes a sub-range between 3 seconds and 6 seconds and a sub-range between 12 seconds and 15 seconds, and corresponds to a symbol “ [symbol] ”. The respective detention-time range TR of the pressure arrange state C03 includes a sub-range between 6 seconds and 9 seconds and a sub-range between 15 seconds and 18 seconds, and corresponds to a symbol “ [symbol] ”. The pressure gauge table GA3 can also have a keyboard configuration of a traditional mobile phone. Under a condition that the combination form B1 is in the state group C81 (in a single-finger pressing), the processing unit 33, according to the state detention time TA1, selects a symbol from the three symbols “ [symbol] ”, “ [symbol] ” and “ [symbol] ”, or selects a code from the three codes K01, K02 and K03.

For instance, the information input device 83 is a communication device. The input information Q1 is a numerical input information; when the operating pressure P1 is released to release the at least one press-button point A11, the information input device 81 generates the input information Q1 corresponding to the just-to-be-released pressure level; and then the user performs a specific operation to perform a dial operation. For instance, the specific operation is one of touching the touch screen 41 more than once.

The information input devices in various embodiments of the present disclosure solve a problem that cannot correctly dial a number with bare hands because of the too small touch screen, and additionally to get the aesthetic.

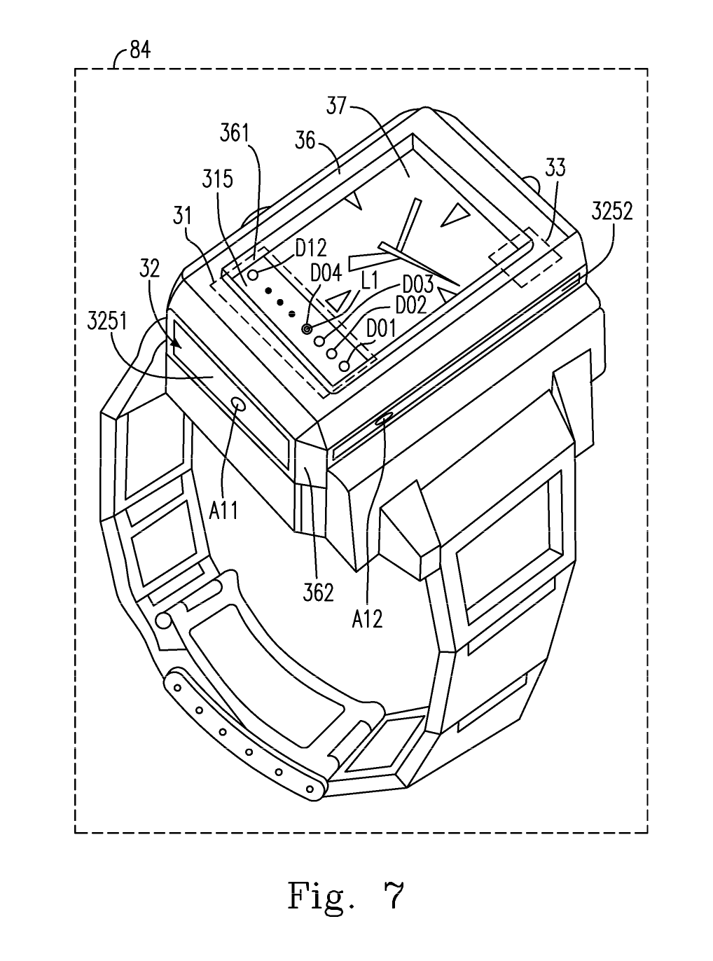

Please refer to FIG. 7, which is a schematic structural diagram showing an information input device 84 according to various embodiments of the present disclosure. The information input device 84 includes a display unit 31, a pressure sensing unit 32, a processing unit 33 and a device body 36. Each of the display unit 31 and the pressure sensing unit 32 is coupled to the processing unit 33 and the device body 36. The processing unit 33 is coupled to the device body 36, or is disposed in the device body 36. The structure and the operating method of the information input device 84 are similar to those of the information input devices 30, 81, 82 and 83. The characteristic features of the information input device 84 are described as follows.

In some embodiments, the device body 36 includes a front portion 361 and a peripheral side portion 362 coupled to the front portion 361. The display unit 31 is disposed on the front portion 361, includes or is a light-emitting diode (LED) display screen 315, and is coupled to the processing unit 33. For instance, the LED display screen 315 is disposed on the front portion 361, is coupled to the processing unit 33, and provides the selection tool L1 and the plurality of position targets D01, D02, D03, D04 . . . and D12 respectively indicating the plurality of pressure arrangement states C01, C02, C03, C04 . . . and C12.

The pressure sensing unit 32 includes at least one pressure sensing panel 3251, or a plurality of pressure sensing panels 3251 and 3252. The plurality of pressure sensing panels 3251 and 3252 are separately disposed on the peripheral side portion 362, and each of the plurality of pressure sensing panels 3251 and 3252 is coupled to the processing unit 33. The processing unit 33 is coupled to the device body 36, or is disposed in the device body 36. For instance, the information input device 84 uses the LED display screen 315, the at least a pressure sensing panel 3251 and the processing unit 33 to cause the information input device 84 to be operated in one of the aforementioned operation modes M1, M2 and M3. For instance, the at least a pressure sensing panel 3251 has the at least one press-button point A11.

In some embodiments, the information input device 84 is a wearable communication device (such as a watch). For instance, the information input device 84 further includes a watch structure 37 coupled to the device body 36. The watch structure 37 is further coupled to the processing unit 33. For instance, the processing unit 33 controls a setting function of the watch structure 37 through the pressure sensing unit 32. The processing unit 33, through the at least a pressure sensing panel 3251, detects the count N1 of the at least one press-button point A11 and the operating pressure P1 to input the numerical input information. The information input device 84 can have the existing fashion appearance of the original wearable communication device, and can also have the conveniently portable function of the original wearable communication device, thereby increasing the willingness that the user uses the information input device 84.

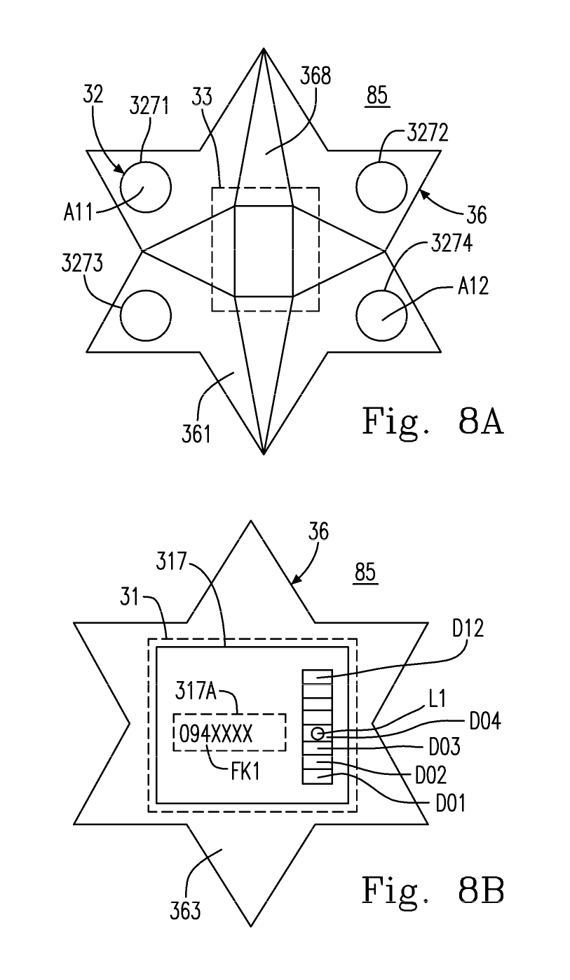

Please refer to FIG. 8A and FIG. 8B, which are schematic structural diagrams respectively showing a front view and a back view of an information input device 85 according to various embodiments of the present disclosure. The information input device 85 includes a display unit 31, a pressure sensing unit 32, a processing unit 33 and a device body 36. Each of the display unit 31 and the pressure sensing unit 32 is coupled to the processing unit 33 and the device body 36. The processing unit 33 is coupled to the device body 36, or is disposed in the device body 36. The structure and the operating method of the information input device 84 are similar to those of the information input devices 30, 81, 82 and 83. The characteristic features of the information input device 84 are described as follows.

In some embodiments, the device body 36 includes a front portion 361 and a back portion 363 opposite to the front portion 361. The display unit 31 is disposed on the back portion 363, and is coupled to the processing unit 33. For instance, the display unit 31 includes or is a display component 317, which is disposed on the back portion 363. The display component 317 provides the selection tool L1 and the plurality of position targets D01, D02, D03, D04 . . . and D12 respectively indicating the plurality of pressure arrangement states C01, C02, C03, C04 . . . and C12.

The pressure sensing unit 32 is disposed on the front portion 361, and includes at least a pressure sensing component 3271, or a plurality of pressure sensing components 3271, 3272, 3273 and 3274. The plurality of pressure sensing components 3271, 3272, 3273 and 3274 is separately disposed on the front portion 361, and each of the plurality of pressure sensing components 3271, 3272, 3273 and 3274 is coupled to the processing unit 33. The input information Q1 has a representative symbol FK1; for example, the representative symbol FK1 is equal to the symbol F04. The display component 317 includes a specific display area 317A. The processing unit 33 is coupled to the device body 36 and causes the display component 317 to display the representative symbol FK1 on the specific display area 317A. For instance, the information input device 85 uses the display component 317, the plurality of pressure sensing components 3271, 3272, 3273 and 3274, and the pressure sensing unit 32 to cause the information input device 85 to be operated in one of the aforementioned operation modes M1, M2 and M3.

In some embodiments, the information input device 85 is a wearable communication device (such as a brooch). For instance, the information input device 85 further includes a brooch structure 368. The processing unit 33, through the plurality of pressure sensing components 3271, 3272, 3273 and 3274, detects the count N1 of the at least one press-button point A11 and the operating pressure P1 to input the numerical input information. The information input device 85 can have the existing fashion appearance of the original wearable communication device, and can also have the conveniently portable function of the original wearable communication device, thereby increasing the willingness that the user uses the information input device 85.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An information input device, comprising:
a pressure sensing unit sensing an operating pressure at a at least one press-button point, and generating a first signal of the at least one press-button point in a first pressure arrangement state;
a display unit providing a selection tool and a first position target indicating the first pressure arrangement state; and
a processing unit, according to the first signal, causing the selection tool to select the first position target, and generating an input information representing the first pressure arrangement state.

2. The information input device according to claim 1, wherein:
the pressure sensing unit includes a pressure sensing panel, wherein the pressure sensing panel includes a pressure sensing array having a pressure sensing area, and each the at least one press-button point is independently located in the pressure sensing area;
the display unit includes a display panel, wherein the display panel and the pressure sensing panel constitute a touch screen;
at a starting instant, the operating pressure is just to be released;
the processing unit detects the starting instant through the pressure sensing unit to generate the input information;
the processing unit stores the input information; and
the processing unit performs one of a dial operation and an information transmission operation according to the input information.

3. The information input device according to claim 1, wherein:
the pressure sensing unit generates a second signal in a second pressure arrangement state different from the first pressure arrangement state;
the display unit provides a second position target indicating the second pressure arrangement state;
the operating pressure changes with time;
the at least one press-button point has a count changing with the time;
the operating pressure has a specific pressure level in a specific one of a plurality of pressure ranges;
each the at least one press-button point has a respective pressure component;
the processing unit digitizes the respective pressure component through the pressure sensing unit to correspondingly generate a respective digitized pressure component expressed by a plurality of bits to obtain a specific digitized pressure level for the operating pressure;
the processing unit, according to the specific digitized pressure level, causes the selection tool to select the first position target, and generates the input information;
the first and the second position targets are respectively marked by a first symbol and a second symbol, and are respectively represented by a first code and a second code respectively representing the first and the second pressure arrangement states, wherein the input information is one of the first and the second codes;
when the count of the at least one press-button point is greater than 1, the operating pressure is a pressure combination of the respective pressure component and the specific digitized pressure level is a level sum of the respective digitized pressure component at a specific time; and
the processing unit causes the information input device to be operated in one of a plurality of operating modes according to an input instruction, wherein the plurality of operating modes include a first operating mode, a second operating mode and a third operating mode.

4. The information input device according to claim 3, wherein when the information input device is operated in the first operating mode:
the at least one press-button point has a count equal to 1;
the processing unit causes the first position target, the second position target and at least a third position target to be arranged in a linear target array on the display unit; and
the plurality of pressure arrangement states are mutually independent.

5. The information input device according to claim 3, wherein when the information input device is operated in the second operating mode:
the at least one press-button point has a count greater than or equal to 1;
the processing unit causes the first position target, the second position target and at least a third position target to be arranged in a plurality of linear target arrays on the display unit; and
the plurality of pressure arrangement states are mutually independent.

6. The information input device according to claim 3, wherein when the information input device is operated in the third operating mode:
the at least one press-button point has a count greater than or equal to 1;
the first pressure arrangement state, the second pressure arrangement state and at least two third pressure arrangement states are divided into a plurality of state groups to cause the plurality of position targets to be correspondingly divided into a plurality of target groups, each of which has a plurality of target members having a specific count, and each of the plurality of state groups has a plurality of state members having the specific count, and has a respective group press-button point count and a respective group pressure range;
the at least one press-button point count has a same count throughout the each state group, and the respective pressure range of each of the plurality of state members is equal to the respective group pressure range throughout the each state group;
the processing unit causes the plurality of position targets to be arranged in a plurality of linear target arrays on the display unit;
the operating pressure has a state detention time for the respective group pressure range, wherein the state detention time is a cumulative time that the operating pressure has fallen within the respective group pressure range of one of the plurality of state groups; and
each of the plurality of pressure arrangement states further has a respective detention-time range to be associated with the state detention time.

7. The information input device according to claim 1, further comprising a device body, wherein:
the device body includes a front portion and a peripheral side portion;
the display unit is disposed on the front portion, includes a light-emitting diode (LED) display screen, and is coupled to the processing unit; and
the pressure sensing unit includes at least a pressure sensing panel disposed on the peripheral side portion, and coupled to the processing unit.

8. The information input device according to claim 1, further comprising a device body, wherein:
the device body includes a front portion and a back portion;
the display unit is disposed on the back portion, and is coupled to the processing unit;
the pressure sensing unit includes a plurality of pressure sensing components separately disposed on the front portion, and each of the plurality of pressure sensing components is coupled to the processing unit;
the input information has a representative symbol; and
the processing unit causes the display unit to display the representative symbol.

9. An information input device, comprising:
a pressure sensing unit sensing an operating pressure at a at least one press-button point, and generating a first signal of the at least one press-button point in a first pressure arrangement state, wherein the operating pressure has a respective pressure component at each the at least one press-button point; and
a processing unit digitizing the respective pressure component through the pressure sensing unit to correspondingly generate a respective digitized pressure component expressed by a plurality of bits to obtain a specific digitized pressure level for the operating pressure, and according to the first signal, generating an input information representing the first pressure arrangement state.

10. The information input device according to claim 9, wherein:
at a starting instant, the operating pressure is just to be released;
the processing unit detects the starting instant through the pressure sensing unit to generate the input information;
the processing unit stores the input information; and
the processing unit performs one of a dial operation and an information transmission operation according to the input information.

11. The information input device according to claim 9, further comprising a display unit, wherein:
the pressure sensing unit generates a second signal in a second pressure arrangement state different from the first pressure arrangement state;
the display unit is coupled to the processing unit, and provides a first position target and a second position target respectively indicating the first and the second pressure arrangement states;
the operating pressure changes with time;
the at least one press-button point has a count changing with the time;
the operating pressure has a specific pressure level in a specific one of a plurality of pressure ranges;
the processing unit, according to the specific digitized pressure level, causes the selection tool to select the first position target, and generates the input information;
the pressure sensing unit includes a pressure sensing panel, wherein the pressure sensing panel includes a pressure sensing array having a pressure sensing area, and each the at least one press-button point is independently located in the pressure sensing area;
the display unit includes a display panel, wherein the display panel and the pressure sensing panel constitute a touch screen;
the first and the second position targets are respectively marked by a first symbol and a second symbol, and are respectively represented by a first code and a second code respectively representing the first and the second pressure arrangement states, wherein the input information is one of the first and the second codes;
when the count of the at least one press-button point is greater than 1, the operating pressure is a pressure combination of the respective pressure component and the specific digitized pressure level is a level sum of the respective digitized pressure component; and
the processing unit causes the information input device to be operated in one of a plurality of operating modes according to an input instruction, wherein the plurality of operating modes include a first operating mode, a second operating mode and a third operating mode.

12. The information input device according to claim 11, wherein when the information input device is operated in the first operating mode:
the at least a press-button point has a count equal to 1;
the processing unit causes the first position target, the second position target and at least a third position target to be arranged in a linear target array on the display unit; and
the plurality of pressure arrangement states are mutually independent.

13. The information input device according to claim 11, wherein when the information input device is operated in the second operating mode:
the at least one press-button point has a count greater than or equal to 1;
the processing unit causes the first position target, the second position target and at least a third position target to be arranged in a plurality of linear target arrays on the display unit; and
the plurality of pressure arrangement states are mutually independent.

14. The information input device according to claim 11, wherein when the information input device is operated in the third operating mode:
the at least one press-button point has a count greater than or equal to 1;
the first pressure arrangement state, the second pressure arrangement state and at least two third pressure arrangement states are divided into a plurality of state groups to cause the plurality of position targets to be correspondingly divided into a plurality of target groups, each of which has a plurality of target members having a specific count, and each of the plurality of state groups has a plurality of state members having the specific count, and has a respective group press-button point count and a respective group pressure range;
the at least one press-button point count has a same count throughout the each state group, and the respective pressure range of each of the plurality of state members is equal to the respective group pressure range throughout the each state group;
the processing unit causes the plurality of position targets to be arranged in a plurality of linear target arrays on the display unit;
the operating pressure has a state detention time for the respective group pressure range, wherein the state detention time is a cumulative time that the operating pressure has fallen within the respective group pressure range of one of the plurality of state groups; and
each of the plurality of pressure arrangement states further has a respective detention-time range to be associated with the state detention time.

15. The information input device according to claim 9, further comprising a device body, wherein:
the device body includes a front portion and a peripheral side portion;
the display unit is disposed on the front portion, includes a light-emitting diode (LED) display screen, and is coupled to the processing unit; and
the pressure sensing unit includes at least a pressure sensing panel disposed on the peripheral side portion, and coupled to the processing unit.

16. The information input device according to claim 9, further comprising a device body, wherein:
the device body includes a front portion and a back portion;
the display unit is disposed on the back portion, and is coupled to the processing unit;
the pressure sensing unit includes a plurality of pressure sensing components separately disposed on the front portion, and each of the plurality of pressure sensing components is coupled to the processing unit;
the input information has a representative symbol; and
the processing unit causes the display unit to display the representative symbol.

17. An information input method, comprising steps of:
sensing an operating pressure formed at a at least one press-button point, wherein the operating pressure has a respective pressure component at each the at least one press-button point;
digitizing the respective pressure component to correspondingly generate a respective digitized pressure component expressed by a plurality of bits;
generating a first signal when the at least one press-button point is in a first pressure arrangement state; and
generating according to the first signal an input information representing the first pressure arrangement state.

18. The information input method according to claim 17, wherein:
at a starting instant, the operating pressure is just to be released; and
the information input method further comprises steps of:
detecting the starting instant to generate the input information; and
performing one of a dial operation and an information transmission operation according to the input information.

19. The information input method according to claim 17, wherein:
the operating pressure changes with time;
the at least one press-button point has a count changing with the time; and
the operating pressure has a specific pressure level in a specific one of a plurality of pressure ranges.

20. The information input method according to claim 19, further comprising steps of:
providing a selection tool and a plurality of position targets, wherein the plurality of position targets includes a first position target and a second position target different from the first position target;
generating a second signal when the at least one press-button point is in a second pressure arrangement state different from the first pressure arrangement state;
when the at least one press-button point is in the first pressure arrangement state, causing the selection tool to select the first position target; and
when the at least one press-button point is in the second pressure arrangement state, causing the selection tool to select the second position target.
